(19) United States
(12) Patent Application Publication
(10) Pub. No.: US 2012/0089989 A1
(43) Pub. Date: Apr. 12, 2012

(54) SYSTEMS AND METHODS FOR EXECUTING AND IMPLEMENTING COMPUTER PROCESSES IN PROCESS ENVIRONMENTS

(76) Inventors: Shane Andrew Mercer, Wellington (NZ); Lindsay Ian Smith, Wellington (NZ)

(21) Appl. No.: 13/376,019

(22) PCT Filed: Jun. 21, 2010
(86) PCT No.: PCT/NZ10/00115

§ 371 Date: Dec. 2, 2011

Related U.S. Application Data
(60) Provisional application No. 61/218,414, filed on Jun. 19, 2009.

(51) Int. Cl. G06F 9/46

(52) U.S. Cl. 719/313

(57) ABSTRACT

In at least one embodiment a computer implemented method is disclosed. A computer process is extracted from a first environment including a unique process parameter and a first non-unique process parameter. The computer process is configured to execute a primary domain operation. The computer process is configured to execute the primary domain operation in a second environment comprising the unique process parameter and a second non-unique process parameter. The unique process parameter is input to the computer process and the primary domain operation is executed with the computer process in the second environment in response to inputting the unique process parameter to the computer process.

### CROSS REFERENCE TO RELATED APPLICATIONS

This application claims priority from U.S. provisional application No. 61/218,414, entitled “EXECUTION ENVIRONMENT,” filed on Jun. 19, 2009, which is incorporated by reference in its entirety, for all purposes, herein.

### FIELD OF TECHNOLOGY

The present disclosure generally relates to the manner in which computer process execution is structured. More particularly, the present disclosure is directed to systems and methods for implementing and executing computer processes in process environments.

### BACKGROUND

Computer processes are implemented in a number of ways and process execution is managed by many different types of environments. Typically, processes perform a variety of common tasks such as retrieval and persistence of data from external systems, authentication of agents participating in process execution, and retrieval of configuration or environmental information used to alter process behavior.

The recording of the transfer of data between executing processes and external data systems is extremely useful to both the implementers of the systems and to the administrators that manage these systems in their executing environments. The ability to recall the data that was transferred from an external system, or the data sent to an external agent, can be used for testing and fault identification purposes.

These operations often vary based on the environment or environments within which the process executes. For example, during the build phase of a user authentication system, the authentication process is executed on a development system that connects to a development version of a database and authenticates users using a simple flat file of usernames and passwords. When the system is deployed to a production environment within for example, a corporation, the connections between the executing process and external information sources must be altered to connect the production database to the company-wide authentication server.

Therefore, there is a need in the art for improved systems and methods for implementing and executing computer processes in process environments.

### SUMMARY

In one embodiment a computer implemented method is provided. A computer process is extracted from a first environment including a unique process parameter and a first non-unique process parameter. The computer process is configured to execute a primary domain operation. The computer process is configured to execute the primary domain operation in a second environment comprising the unique process parameter and a second non-unique process parameter. The unique process parameter is input to the computer process and the primary domain operation is executed with the computer process in the second environment in response to inputting the unique process parameter to the computer process.

In another embodiment a device comprising a processor is provided. The processor is configured to provide the following: a process environment comprising at least one unique process parameter and at least one non-unique process parameter; a computer process configured to execute a primary domain operation in the process environment is provided; an interface for transmitting data to the computer process through the interface; a request for the execution of a data retrieval operation. The processor is further configured to receive data from the data retrieval operation through the interface in response to the request for the execution of the data retrieval operation and input the unique process parameter and the data to the computer process. The computer process executes the primary domain operation in response to inputting the unique process parameter and the data to the computer process.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Embodiments of the present application are described, by way of example only, with reference to the attached Figures, wherein:

FIG. 1 illustrates an exemplary computer process executed by an execution system in a process environment according to one embodiment;

FIG. 2 illustrates an exemplary computer process executed by an execution system in a process environment according to another embodiment;

FIG. 3 illustrates an exemplary system and method for the retrieval of data through a process environment interface;

FIG. 4 illustrates an exemplary system and method for authentication through a process environment interface; and

FIG. 5 illustrates an exemplary system and method for transferring data to and from an initiating system through a process environment interface.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, methods, procedures and components have not been described in detail so as not to obscure the embodiments described herein. Systems and methods for implementing and executing computer processes in process environments are herein disclosed.

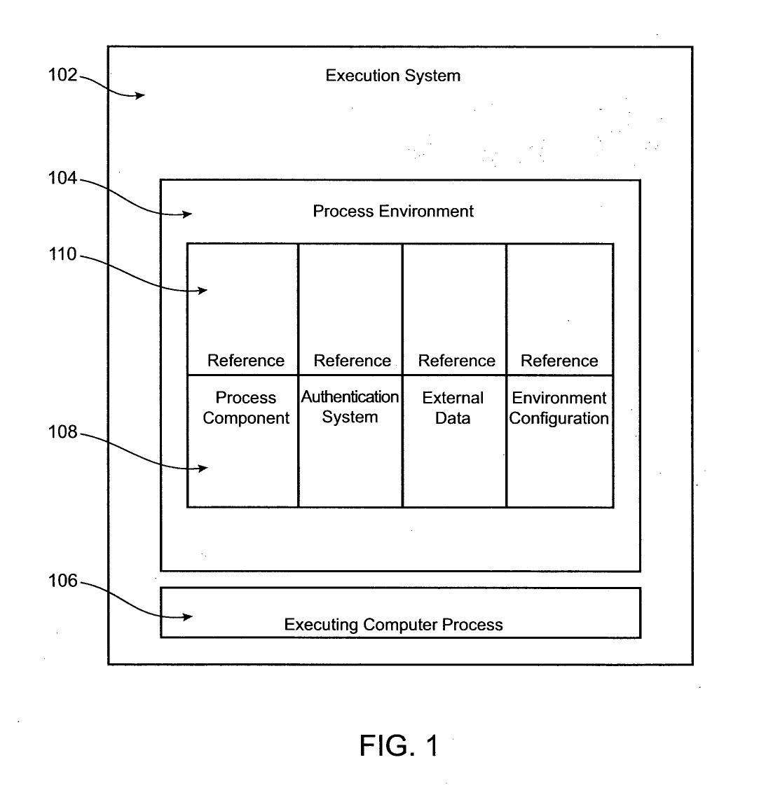

FIG. 1 illustrates an exemplary computer process 106 executed by an execution system 102 in a process environment 104 according to one embodiment. The executing computer process 106 executes one or more tasks or operations directly related to a primary domain operation that the executing computer process 106 was designed to execute. The executing computer process 106 is executed within a process environment 104 by an execution system 102. The process environment 104 can reside on the execution system 102 or can be external to the execution system 102. The process environment 104 includes unique process parameters and attributes 108 and non-unique parameters and attributes 108 including, but not limited to process component parameters and attributes, authentication system parameters and attributes, external data parameters and attributes and process environment parameters and attributes including process environment configuration characteristics. Unique process parameters and attributes 108 are utilized by the executing computer process 106 to execute the primary domain operation. Non-unique parameters and attributes 108 are utilized by external systems, agents or processes collateral or external to the primary domain operation and in some cases are also used by the executing computer process also. Unique process parameters and attributes 108 and non-unique parameters and attributes 108 can be referenced with identifiers 110 which can be stored within the process environment 104.

A structural embodiment of an execution system 102 can include for instance, one or more primary servers executing the executing computer process 106 within the process environment. A structural embodiment of a process environment 104 can include for instance, one or more servers, a communication network for providing communication between the process environment 104, the executing system 102 and the executing computer process 106 and computer code implemented in a computer readable medium such as a hard disc for executing operations. A structural embodiment of an executing computer process 106 can include for instance, computer code implemented in a computer readable medium such as a hard disc for executing the primary domain operation.

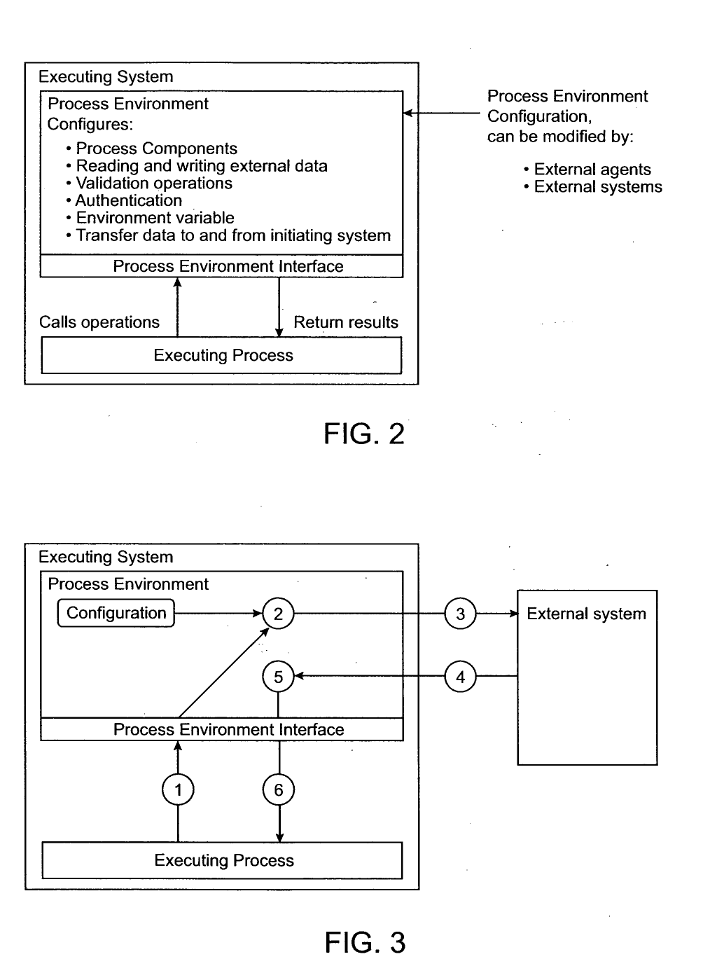

FIG. 2 illustrates an exemplary computer process executed by an execution system in a process environment according to another embodiment. A structural embodiment of an execution system can include for instance, one or more primary servers executing the executing computer process within the process environment. A structural embodiment of a process environment 104 can include for instance, one or more servers and a communication network for providing communication between the process environment, the executing system and the executing computer process and computer code implemented in a computer readable medium such as a hard disc for executing operations. A structural embodiment of an executing computer process can include for instance, computer code implemented in a computer readable medium such as a hard disc for executing the primary domain operation.

### Overall System and Process

An executing computer process is executed by an execution system that can at least initiate and manage the operation of the executing computer process. The executing computer process is executed in a process environment that is accessible by the execution system. Any communication with external systems, agents or processes collateral to or external to the primary domain operation is separately performed by an entity, agent, system or process other than the executing computer process. The executing computer process only executes tasks directly related to the primary domain operation. In an exemplary embodiment, the execution system is a web server that initiates the execution of the executing computer process in response to requests from a web browser.

The process environment can reside on the execution system or can be external to the execution system. The configuration of the process environment can include parameters and attributes characterizing process components, the reading and writing of external data, validation operations, other external and internal systems, user and data authentication operations, the transfer of data from an initiating system (e.g., executing system or other external system) and other process environment variables. The configuration of the process environment and data relevant to the operation of the process environment can be modified by one or more external agents or systems. The configuration of the process environment and data relevant to the operation of the process environment can also be modified by one or more external automated systems. In an exemplary embodiment, the process environment can provide a mechanism via a web browser to inspect and alter its configuration by an automated administrator or by a user.

The process environment includes unique process parameters and attributes and non-unique parameters and attributes including, but not limited to process component parameters and attributes, authentication system parameters and attributes, external data parameters and attributes and process environment parameters and attributes including process environment configuration characteristics. Unique process parameters and attributes are utilized by the executing computer process to execute the primary domain operation. Non-unique or reusable parameters and attributes are utilized primarily by external systems, agents or processes collateral or external to the primary domain operation, but in some cases can also be used by the executing computer process. Unique process parameters and attributes and non-unique parameters and attributes can be referenced with identifiers that are stored within the process environment. By separating and moving non-unique aspects of process execution including non-unique or reusable parameters and attributes out of the primary domain operation and into shareable and reusable components, the executing computer process operates only to execute the primary domain operation, thereby making operation of the executing computer process more efficient and focused to the primary operational task.

The executing system provides a communication channel for the executing computer process to communicate and interact with the process environment via a process environment interface. The process environment interface is a mechanism through which an executing computer process can transmit and receive data, communicate and interact with the process environment. A reference to an attribute or parameter of the process environment interface is made available to the executing computer process executed by the executing system. The executing system can provide the process environment interface through the executing computer process based, at least in part, on the one or more attributes or parameters of the process environment interface. The executing system monitors, communicates with and/or records one or more parameters or attributes of the executing computer process and the process environment. The process environment interface monitors, communicates with and/or records one or more parameters or attributes of the executing computer process that is calling operations on the process environment interface. In this way, the operations called on the process environment interface can be made dependent upon the executing computer process that is calling the operation.

Many general tasks can be shared between multiple instances of process execution within the process environment including the execution of processes collateral to the primary domain operation. These general tasks are often not related to the primary domain operation that the executing computer process is designed for. For example, the calculation of the statistical mean of a set of numbers is a general task that may be used in many situations. Exactly which set of numbers are to be used would be the specific to the executing process. Using a web browser as an example, a process component can perform the task of displaying a table of records to a user and provide sorting and search facilities within that table. These general tasks a separated from the definition of the primary domain operation in order to focus and concentrate the executing computer process only on the execution of the primary domain operation.

The retrieval of process components via the process environment interface can occur through the executing system that executes the executing computer process. However, process components can be modified, corrected or improved after the primary domain operation has been defined and the executing computer process can make use of modified, corrected or improved process components, because their retrieval occurs dynamically during execution of the executing computer process. In this way, the process components can be modified and used immediately by the executing computer process and other external systems, agents or processes depending on the operation they are being used to perform and the environment in which the operation is performed.

The process environment interface can be used to call or initiate one or more operations requiring the entry or verification of one or more parameters. When called or initiated, these operations are performed by the process environment and the result returned through the process environment interface to the calling or initiating process. One or more process environment interfaces can be provided to support and facilitate the following tasks: process component retrieval, data retrieval and persistence, agent, system or data authentication, process environment configuration parameter retrieval, access to data sent by an initiating system, and transfer of data to an initiating system.

In an exemplary embodiment, a process component is an executable component that operates dependent upon at least some part, attribute or parameter of the process environment interface. The executing computer process can make use of this process component by supplying the executing computer process or other process with information or a request that designates the display of specific data through the process environment interface.

### Data Retrieval

One very common form of external system interaction is the retrieval of data from an external system such as a database or a web service, and the persistence of data to these systems. The process environment includes an operation for retrieval of data external or internal to the process environment and which can be called by an external agent, system or process or the executing computer process. One or more of the following parameters can also be called by an external agent, system or process or the executing computer process along with an operation for retrieval of external or internal data: an identifier of an external data source from which to retrieve the data, an identifier designating the type of data retrieval to perform, a set of the parameters required by a particular data retrieval operation. In this way, the addition of data access logic to the design of the executing computer process or other internal or external data retrieval processes or systems is not required. The auditing or recording of interactions with the external systems is more easily manage when the addition of data access logic is not required.

Any external data or system source thereof can be referenced in the process environment with an identifier. The identifier can be any descriptive data, such as a word (e.g., “CustomerRecords”), used to identify the external data and/or external data source. Identifiers can be made specific to the primary domain operation so they do not change when the executing computer process is migrated to or implemented in one or more different process environments.

The process environment can utilize a supplied data identifier along with internal configuration parameters of the object or entity being identified in order to identify and communicate with the external system or entity supplying the data. The process environment can be configured by an administrator to pair data identifiers with the information required to initiate communication with the system supplying the data. The data identifier can be bound to or associated with different attributes or identifiers of external systems depending on the process environment (e.g., process environment in development stage or process environment in production stage) for which the external system is supplying data. The configuration of the process environment and the manner in which it requests and obtains data from external or internal systems can be modified at any time (e.g. even during execution of the executing computer process) without the need for an additional configuration modifying process. The process environment can be configured to an initial state before the implementation and execution of the executing computer process to simplify deployment. External systems and data obtained therefrom can also be used and shared by the executing computer process and other external or collateral agents, systems or processes despite the provision and use of different identifiers for a particular external data system or data received therefrom.

The executing computer process can include a reference or identifier that specifies the type of data retrieval to perform (e.g. ‘AllCustomersByRegion’). The identifier can characterize the nature of quires that are made against an external system. One or more of these identifiers can be made specific to the executing computer process and they do not change when that executing computer process is implemented or executed in other process environments. The process environment can be programmed to account for and utilize its own configuration to determine the exact nature of a data retrieval operation. For example, the process environment configuration can specify that the retrieval of a particular data set is implemented by a particular SQL query file and is not needed for the executing computer process to execute the primary domain operation. Because the process environment configuration specifies that a particular data set or operation to retrieve the data set is not needed for the executing computer process to execute the primary domain operation, the data set or operation to retrieve the data set may vary between process environments without undue burden to the execution of the primary domain operation.

A specific data retrieval operation can require a set of parameters to be considered before execution of a specific process. All the required parameters can be provided when a specific data retrieval operation is invoked upon the process environment interface. For example, the identifier of the region from which to retrieve a list of customers is a parameter that can be considered before execution of a specific process.

FIG. 3 illustrates an exemplary system and method for the retrieval of data from an external system and through a process environment interface. In step 1, a process including, but not limited to an executing computer process and/or processes external or collateral to the primary domain operation being executed can call a data retrieval operation by initiating and sending a request through the process environment interface. The calling process can supply information through the process environment interface and to the data retrieval operation including, but not limited to an abstract identifier of an external system providing the data, an identifier of the data retrieval operation type, and/or other parameters required for the data retrieval operation. In step 2, the process environment can make a determination of which external system to use based on the identifier supplied by the executing process and the configuration parameters and attributes of the process environment. The process environment can also execute or determine the result of one or more validation operations that can be configured specifically to validate the data being retrieved or the process used to retrieve the data. In step 3, the process environment can establish communication through a communication channel with the external system providing the data to transmit any required information, parameters, attributes or requests related to the data retrieval operation. In step 4, the external system returns the requested data to the process environment through a communication channel. In step 5, the process environment receives the data from the external system and can augments the data with one or more validation operations if the configuration parameters and attributes of the process environment require the validation operation. In step 6, the process environment transmits or returns data and, if required, transmits or returns the result of validation operations through the process environment interface to the executing process.

The process environment configuration that specifies, in part, the nature of retrieval of a particular data can further include one or more operational constraints for the retrieval of data or other operational constraint. The operational constraint can require an additional authentication or validation operation, for example that authenticates or verifies the nature of the data being retrieved and where the data is retrieved from. When a request is made by an external agent, system or process or by the executing computer program, the returned data can include an identifier and an indication of the operational constraint that applies to or is associated with the request for retrieval of the data. In this way, external agent, system or process or the executing computer process can determine if the data conforms to the operational constraints. An operational constraint can be changed or modified, which will affect the operation which the constraint is associated with (e.g., operational constraint on the nature of data retrieved internal or external to the process environment), without having to modify the external system, agent or process or the executing computer process that use the data. Any one or more operational constraints can be defined and implemented into the configuration of the process environment by an administrator or user. Operational constraints can be specific to operations that are collateral to or separate from the executing computer process and the primary domain operation. Therefore, including operational constraints within the configuration of the process environment that are collateral to or separate from the executing computer process does not affect the focused functionality of the executing computer process or the execution of the primary domain operation. In an exemplary embedment, an operational constraint can specify that a customer must have a contact email address, or that a customer cannot place an order if their balance is in arrears.

### Data Persistence

The process environment interface can be used to perform or facilitate the performance of operations for the persistence of data to external systems by providing an interface wherein general communication, requests and data can be shared between the process environment and the executing computer process. The data persistence operation can include, but is not limited to the following parameters: the data to persist; identifier of the data to persist; an identifier of the external system to persist the data to, an identifier for the data persistence operation type. The identifier of the external system may only be required where the data was not originally retrieved from an external system. In that case, the execution system, process environment or the external system can reuse the identifier used in retrieval. Similarly, the data persistence operation type may be used to identify the method of persistence (such as the query to use in the case of a SQL database). Both of these identifiers can be interpreted, stored or utilized by the process environment along with the process environment configuration parameters and attributes in order to determine the final external system and operation to perform.

### Authentication

The process environment can implement an authentication operation. The authentication process can be used to validate or authenticate the identity or nature of data, systems, agents or processes internal or external to the process environment. The authentication operation can be called by the executing computer process or by some other system, agent or process external to the executing computer process. The process environment can determine the correct method of authentication to use for the process that called the authentication operation by referring to and utilizing process environment configuration parameters and attributes. Process environment configuration parameters and attributes can include an indication of the method of authentication (e.g. an LDAP query) and/or any other information relevant to that type of authentication (e.g. the LDAP connection string).

The process environment configuration parameters and attributes used to implement and execute the authentication process are independent and separate from the executing computer process. During an authentication process called by the executing computer process, the operations performed by the executing computer process during authentication are not dependent on process environment configuration parameters and attributes used to implement and execute the authentication process. This allows the executing computer process and its functionality to remain specific executing the primary domain operation. Therefore, process environment configuration parameters and attributes used to implement and execute the authentication process can vary between process environments or execution systems within which the overall system and process is deployed. Adding a new method of authentication to an executing system can be achieved without modification of the executing computer process executing the primary domain operation.

The process environment interface can be used to perform and facilitate the performance of an authentication process by providing an interface wherein general communication, requests and data can be shared between the process environment and the executing computer process. This operation is supplied with the other information including credentials of data, systems, agents or internal or external processes being authenticated. In the case of an agent the credentials can include a username and password of the agent.

The process environment determines the method of authentication to use for the executing process and can establish communication with any required external systems to receive the authentication result therefrom. Authentication data indicating the result of the authentication process can then be transmitted through the process environment to the process that requested the authentication. The process environment can record the outcome of the authentication request for auditing or other operational purposes. The process environment can add additional information to the outcome of the authentication including, but not limited to a list of permissions configured to be added separate from the authenticating system.

By moving process environment configuration parameters and attributes related to all authentication processes exclusively within the process environment, the executing computer process and the primary domain operation being executed are independent of the authentication parameters and attributes used to accomplish the authentication. In this way, the primary domain operation and the executing computer process is defined more succinctly in that it can assume that the authentication services will be provided regardless of the manner in which it is provided. Authentication services can be easily shared between different instances of process execution (e.g., executing computer process or some other process external or collateral to the primary domain operation). New authentication mechanisms can be added to executing system and the results can be made available to executing computer process without modifying the executing computer process or the primary domain operation it is executing. Also, auditing of authentication requests and results thereof can be provided independent and outside of the executing computer process or the primary domain operation it is executing.

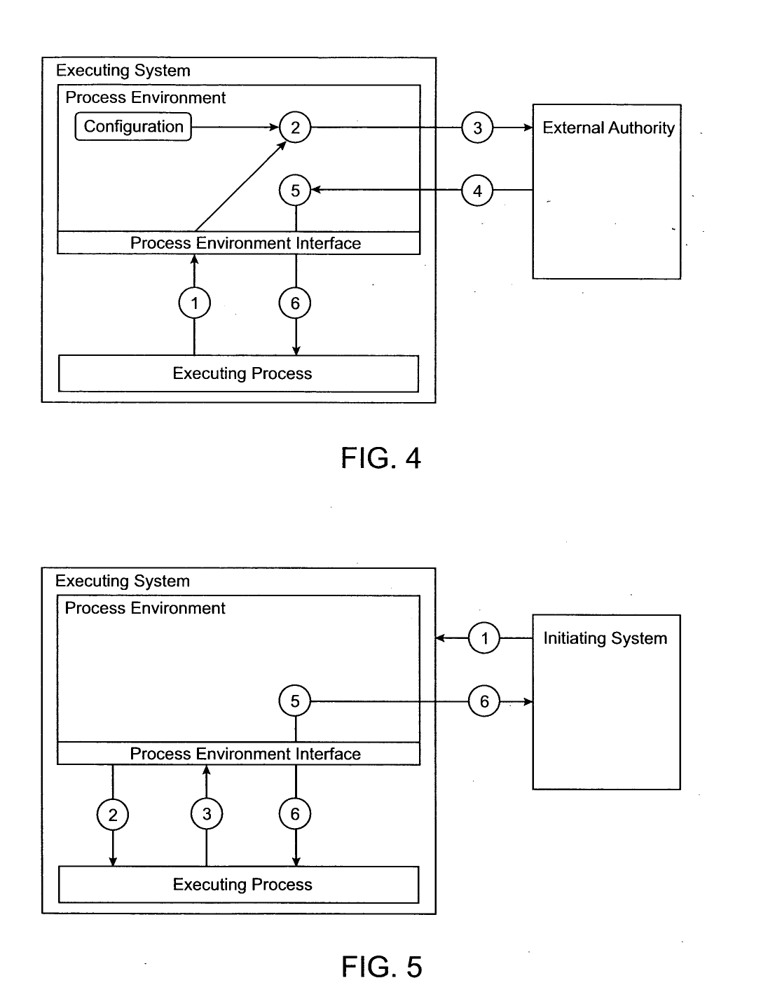

FIG. 4 illustrates an exemplary system and method for authentication through a process environment interface. The process environment can implement an authentication operation. The authentication process can be used to validate or authenticate the identity or nature of data, systems, agents or processes internal or external to the process environment. In step 1, an executing process including, but not limited to an executing computer process and/or processes external or collateral to the primary domain operation being executed can make a request for authentication of the identity or nature of data, systems, agents or processes internal or external to the process environment. The request for authentication can be initiated and transmitted through the process environment interface. The request can include, but is not limited to a request for the validation or credentials of data, systems, agents or processes internal or external to the process environment. In step 2, the process environment determines an authenticating authority to service the request based on the configuration parameters and attributes of the process environment and/or based on the parameters and attributes of the process performing the authentication operation. In step 3, the process environment establishes communication through a communication channel with the authenticating authority in order to determine the authentication status of the data, systems, agents or processes being authenticated. The process environment transmits credentials identifying the data, systems, agents or processes being authenticated to the authenticating authority. In step 4, the authenticating authority returns or transmits the authentication status of the data, systems, agents or processes associated with the credentials supplied by the process environment. In step 5, the process environment can perform any further necessary transformation on authentication results provided by the authenticating authority. In step 6, the process environment returns or transmits the authentication status or an indication of the authentication result to the process that initiated the request for authentication.

Transfer of Data to and from an Initiating System

The manner in which process execution is initiated is often of high importance to the functioning of that process. The execution of processes including the executing computer process and processes external or collateral to the primary domain operation are often performed in response to some external system communicating with the executing system. The execution of the process may require the utilization of data provided from an external system. The retrieval of data sent from external systems for initiating execution of a process and the transmission of data to external systems for initiating execution of a process can be facilitated and provided through the process environment interface.

In an exemplary embodiment of a primary domain operation performed in response to some external system communicating with the executing system, a web browser making a request to a web server is an external system initiating process execution. In this case, primary domain operation is designed to create a web page for the web browser to display. The executing computer process executing the primary domain operation can require data that is supplied with the web request in order to perform its function. For example, the request can specify a customer number that the page is being supplied for. The resulting web page is returned to a client via the web response mechanism.

FIG. 5 illustrates an exemplary system and method for transferring data to and from an initiating system through a process environment interface. In step 1, an initiating system can make an initiation request to the executing system herein disclosed to initiate a process including, but not limited to an executing computer process and/or processes external or collateral to the primary domain operation being execute. The initiation request can include a data or a request for data required to execute the process being initiated. The initiation request can also include data that identifies one or more parameters or attributes of the process being initiated. In step 2, the executing system can initiation execution of the process requested for initiation. The process requested for initiation can store, determine or utilize a reference or identifier of the process environment interface to make requests, transmit data and receive data through the process environment interface. In step 3, the process requested for initiation can request any data associated with the initiation request made by the initiating system. The process environment returns or transmits the data associated with the initiation to the process requested for initiation through the process environment interface. In step 4, the process requested for initiation can determine and compile response data that is transmitted to the initiating system to provide an indication of the initiation of the process. The response data can be transmitted through the process environment interface via an operation residing thereon and to the initiating system to provide an indication of the initiation of the process. In step 5, the process environment can alter or record data supplied by the process requested for initiation. In step 6, the process environment can send final response data to the initiating system to indicate that the initiation of the process has been completed.

Retrieval of Data from Initiating System

A process including the executing computer process and/or processes external or collateral to the primary domain operation being executed in the process environment can retrieve data sent from an external system initiating the execution of the process by calling an operation on the process environment interface that facilitates the transmission and/or retrieval of data. This operation can include, but is not limited to the request for and utilization of a reference, name or identifier of a data field. The reference, name or identifier of the data field can be returned through and/or displayed at the process environment interface. In the case where the data supplied is a simple list of data arranged by an identifier, process execution may retrieve the value of a data field by supplying the identifier. The process environment can retrieve the value from the request that originated from the external system and return it to the executing process. In the case of a web browser, this may be the request parameters passed with the web request.

### Returning Data to the Initiating System

The process environment interface provides an operation for returning data calculated by process execution to the initiating system. In the case of a web browser, this may be the HTML page that is displayed in the browser.

This operation can include, but is not limited to the request for and utilization of the following parameters: the data to send; the type of data; and information about the data. The data to send can be raw information that is ultimately returned to the initiating system. In the web case, this would be the HTML. The type or category of the data can, for example, be used to indicate to the initiating system the correct manner to display the data (for example a mime type in the web browser example). Information about the data can contain, for example, whether the data may be cached or must be retrieved from a source location each time.

By having all request and response data marshaled through the process environment, it allows the process environment to add automatic auditing to any requests and responses. In addition, it makes it possible to record session activity and to then replay that session at a later time. Instead of an actual external system making the request to the executing system, the process environment can initiate the execution of the executing computer process and/or processes external or collateral to the primary domain operation being executed with an exact copy of the data sent from the initiating system. The initiated process would operate in the same way as if a genuine external request were made, because access to the request for information is processed through the process environment interface. When the calculated data is sent by the process being executed through the interface, the process environment can make a comparison of the resulting data with the data that it recorded from the session it is reproducing. If a disparity between the two values exists the process environment or executing system can provide an indication that the system is malfunctioning through the process environment interface. This ability to impersonate the effect of external systems on the executing system has important benefits as it allows a process to be automatically tested after a system upgrade, or for performance testing to be carried out in an automated way.

An executing computer process executing a primary domain operation can be executed in a process environment. The following algorithm can be used to execute a component within the process environment interface:

ProcessExecutionComponent
// perform execution, given a ProcessEnvironment, can return something
function execute(ProcessEnvironment environment) returns Object
end interface
// Data returned through the ProcessEnvironment interface Dataset
// Has the ability to validate itself
function validate( )
// This example contains tabular data
function getData( ) returns String[ ][ ]
end interface
// The interface of the ProcessEnvironment provided to all process
execution interface ProcessEnvironment
// Retrieve a ProcessExecutionComponent with the given identifier, with
some optional properties
function retrieveProcessExecutionComponent(String
componentIdentifier, Map properties) returns ProcessExecutionComponent
// Retrieve a dataset from an external system, named by the source, with a
given operation name
// plus a set of parameters
function retrieveDataset(String sourceName, String operationName, Map
parameters) returns Dataset
// persist a Dataset to external storage
function persistDataset(Dataset data)
// Perform authentication checks
function authenticate(String username, String password) returns boolean
// Retrieve execution data used to initiate execution
function getExecutionData( ) returns Map
// Return data to the system that initiated execution
function returnExecutionResult(Object result)
end interface

Process execution components can be retrieved for non-unique tasks as part of process execution for a unique process can be described with the algorithm below. In this example, the executing computer process calculates the bonus amount applicable for a given sales figure. The sales figure is provided through the execution data that is supplied through the process environment. The result is returned through the process environment. In this example, the sales figure must be converted from Euros to US dollars. A process component for converting from Euros to US dollars is available through the process environment. In this example, the calculation of the bonus is a task unique to the executing computer process and the primary domain operation. The conversion of Euros to U.S. dollars is a non-unique, general task. Having the definition of the non-unique tasks available through the process environment interface allows the unique process definition or the primary domain operation to remain focused on the unique aspects of the process. The non-unique components can then be updated, modified, improved without changing the unique process. The following algorithm supports such an executing computer process executing a primary domain operation such as calculation of a bonus with a collateral operation of converting from Euros to U.S. dollars:

```
structure CalculateBonus implements ProcessExecutionComponent
    function execute(ProcessEnvironment environment) {
      salesFigure = environment.getExecutionData( ).get(“sales-figure”)
      // Retrieve the component, using the salesFigure as a input
      parameter
      ProcessExecutionComponent convertor =
          environment.retrieveProcessExecutionComponent(“euro-
to-dollar-convertor”, { input: salesFigure })
      // Execute the component, retrieving the result
      dollarFigure = convertor.execute(environment)
      // Take 10% of it
      bonusAmount = dollarFigure * 0.1
      environment.returnExecutionResult(bonusAmount)
    }
end structure
```

In an exemplary embodiment, an executing computer process calculates the bonus amount applicable for a given sales figure and a collateral process for the conversion of Euros to U.S. dollars is can be implemented in a process environment with the use of the following algorithm:

```
structure ProcessEnvironmentImplementation implements
ProcessEnvironment
    componentStore = new Map( )
    constructor( )
        componentStore.put(“euro-to-doillar-convertor”, new
EuroToDollarConvertorFactory( ))
        componentStore.put(“euro-to-pound-convertor”, new
EuroToPoundConvertorFactory( ))
    end constructor
    function retrieveProcessExecutionComponent(String identifier,
    Map parameters)
        factory = componentStore.get(identifier)
        return factory.makeProcessExecutionComponent(parameters)
      end function
```

In an exemplary embodiment, the executing computer process can retrieve data from external systems through the process environment. In this example, the executing computer process retrieves a set of customer invoice data to calculate an invoice total. The following algorithm can support this functionality:

```
structure CalculateCustomerInvoiceTotal implements
ProcessExecutionComponent
    function execute(ProcessEnvironment environment)
        // Retrieve the list of customer invoice lines for a given customer
        invoiceLines = environment.retrieveDataset(“customer-invoice-
lines”, “get-all-for-customer”, { customerID: “44526” })
        sum := 0
        for i := 1 to invoiceLines.getData.length
            // invoice amount is 4th field along of each row
            sum := sum + invoiceLines.getData( )[i][4]
        end for
        // return sum as output
        environment.returnExecutionResult(sum)
    end function
end structure
```

The data persistence operation can similarly be handled by the process environment. In this example the executing computer process retrieves the customer invoice data, modifies it by adding a new row, and then persists it by passing it back through the process environment. The following algorithm can support this functionality:

```
structure AddCustomerInvoice implements ProcessExecutionComponent
    function execute(ProcessEnvironment environment)
        // Retrieve the list of customer invoice lines for a given customer
        invoiceLines = environment.retrieveDataset(“customer-invoice-
lines”, “get-all-for-customer”, { customerID: “44526” })
        numLines = invoiceLines.length
        // add a new row
        invoiceLines.getData( )[numLines + 1] = [“cust1”,
        “product4”, “98”, “1877.34”]
        // persist the data through the ProcessEnvironment
        environment.persistDataset(invoiceLines)
    end function
end structure
```

The process environment can implement the retrieval and persistence of data with the use of the following algorithm:

```
structure ProcessEnvironmentImplementation implements
ProcessEnvironment
    externalSystems = new Map( )
    allOperations = new Map( )
    allPersistOperations = new Map( )
    constructor( )
        externalSystems.add(“customer-invoice-lines”,
        “192.168.0.3/invoices”)
        // Define the retrieval operations
        allOperations.add(“get-all-for-customer”, “SELECT *
FROM INVOICES WHERE CUSTOMERID=$customerID”)
        allOperations.add(“get-all”, “SELECT * FROM INVOICES”)
        // Define the persistence operations
        allPersistOperations.add(“customer-invoice-lines”,
                          “INSERT INTO INVOICES
VALUES $customerID, $productID, $quantity, $total”)
    end constructor
    function retrieveDataset(String sourceName, String operationName,
Map parameters) returns Dataset
        system = externalSystems.get(sourceName)
        connection = connectToExternalSystem(system)
        operation = allOperations.get(operationName)
        finalQuery = substituteParameters(operation, parameters)
        // Create a dataset and fill it with data from the result of
        running the query
        result = new Dataset( )
        result.fillFrom(connection.executeQuery(finalQuery))
        // attach the name of the external system to the Dataset for
        use in persistence
        result.systemName = sourceName
        return result
    end function
    function persistDataset(Dataset data)
        systemName = data.systemName
        persistOperation = allPersistOperations.get(systemName)
        connection = connectToExternalSystem(system)
        finalQuery = substituteParameters(persistOperation, data)
        connection.executeQuery(finalQuery)
    end function
end structure
```

In an exemplary embodiment, the process environment can be configured to include parameters such as, the location of the external systems, their identifier, a set of operations that can be executed, and a process to persist data to each external system. When requested to return a dataset, the process environment can use the stored information to connect to the external system, run the query, and return the result. When persisting, the process environment can look up the persistence method for the specific external system and can apply the method to the persisted dataset. The process environment can choose to retrieve a dataset based on some prior result. The following algorithm can support this functionality:

```
structure TestingProcessEnvironmentImplementation implements
ProcessEnvironment
    recordedOperations = new Map( )
    constructor( )
        recordedOperations.add(“get-all-for-customer”, new
Dataset([“cust1”, “product1”, “23”, “345.32”],
            [“cust1”, “product2”, “5”, “5.98”])
    end constructor
    function retrieveDataset(String sourceName, String operationName,
Map parameters) returns Dataset
        // The environment returns the result recorded against that
        operation name,
        // simulating the presence of the external system
        return recordedOperations.get(operationName)
    end function
end structure
```

In this way, the executing process can be executed in a situation where the external systems are not available, or where the system is being tested for conformance to some past observed behavior. Data retrieved can be augmented with operations for determining validity of that data. The datasets provided by the process environment can be augmented by first determining the validity of the data. For example, a process might retrieve a dataset, modify the contents, and then check the validity of the modified data with the use of the following algorithm:

```
structure EditCustomerDetails implements ProcessExecutionComponent
    function execute(ProcessEnvironment environment)
        // Retrieve the details for a customer
        customerDetails = environment.retrieveDataset(“customer-db”,
“get-customer-details”, { customerID: “44526” })
        // modify something - the email address is the 5th item in the
        customer row customerDetails.getData( )[1][5] =
        “john@example.com”
        // Check that the customer data is still valid
        if (customerDetails.isValid)
            // persist the data through the ProcessEnvironment
            environment.persistDataset(customerDetails)
        else
            error “The email address is not valid”
        end if
    end function
end structure
```

The previous example of data retrieval and augmentation can be implemented by the process environment with the use of the following algorithm:

```
structure ProcessEnvironmentImplementation implements
ProcessEnvironment
    externalSystems = new Map( )
    allOperations = new Map( )
    allValidators = new Map( )
    constructor( )
        externalSystems.add(“customer-db”,“192.168.0.3/customers”)
        // Define the retrieval operations
        allOperations.add(“get-customer-details”, “SELECT *
FROM CUSTOMERS WHERE CUSTOMERID=$customerID”)
        all Validators.add(“get-customer-details”, [ new
        EmailValidator( ) ]);
    end constructor
    function retrieveDataset(String sourceName, String operationName,
Map parameters) returns Dataset
        system = externalSystems.get(sourceName)
        connection = connectToExternalSystem(system)
        operation = allOperations.get(operationName)
        finalQuery = substituteParameters(operation, parameters)
        // Create a dataset and fill it with data from the result of
        running the query
        result = new Dataset( )
        result.fillFrom(connection.executeQuery(finalQuery))
        // Add validators
        validators = allValidators.get(operationName)
        result.addValidators(validators)
        // attach the name of the external system to the Dataset for
        use in persistence
        result.systemName = sourceName
        return result
    end function
end structure
```

The dataset can be validated with the use of the following algorithm:

```
structure DatasetImplementation implements Dataset
    validators = new List( )
    function addValidators(Validator[ ] validators)
        validators.addAll(validators)
    end function
    function isValid( )
        for each validator in validators
            if not validator.isValid(this)
                return false
            end if
        next validator
        return true
    end function
end structure
```

The validating system or entity can be implemented in the process environment with the following algorithm:

```
structure EmailValidator implements Validator
    function isValid(Dataset dataset)
        // Check the 5th record of each row, where the email address
        is stored
        for i := 1 to dataset.getData( ).length
            value = dataset.getData( )[i][5]
            if not isValidEmailAddress(value)
                return false
            end if
        next i
        return true
    end function
end structure
```

In an exemplary embodiment, the process environment can provide one or more executing processes to perform an authentication operation with the use of the process environment interface. The following algorithm can be used.

```
// This component checks authentication of a user before retrieving some
sensitive data
structure RetrieveCustomerCreditHistory implements
ProcessExecutionComponent
    function execute(ProcessEnvironment environment)
        username = “user123”
        password = “pa55w0rd”
        if not (environment.authenticate(username, password)
            error “Not authorized to view credit history”
        end if
        creditHistory = environment.retrieveDataset(“credit-history”,
“get-customer-credit-history”, {customerId: “5937” })
        ... read history etc ...
    end function
end structure
```

The process environment can implement the authentication operation with the following algorithm:

```
structure ProcessEnvironmentImplementation implements
ProcessEnvironment
    allUsers = new Map( )
    constructor( )
        allUsers.add(“user1”, “freckles”)
        allUsers.add(“user44”, “god”)
        allUsers.add(“user123”, “pa55w0rd”)
    end constructor
    function authenticate(String username, String password) returns
    boolean
        if allUsers.contains(username)
            if allUsers.get(username) == password
                // pass
                return true
            end if
        end if
        // fail
        return false
    end function
end structure
```

This construction allows the executing computer process and the primary domain operation to be defined or written independent of the method of authentication. The process environment within which the authentication operation occurs can use an external or an organization's authentication system to perform the authentication. Authentication can also be guaranteed for all users if the authentication is being performed for testing or training purposes.

Data can be sent and received by an external system through the process environment interface. Components used in process execution often need to respond to data provided when execution was initiated. For example, a web application that responds to browser requests can inspect the parameters passed in the web request. The result of execution might also be required to be passed back to the initiating entity or operation. For example, the result of execution in a web application can include the HTML content of the page displayed at the browser. An execution component utilizing this capability can be constructed with the following algorithm:

```
structure CustomerDetailsPage implements ProcessExecutionComponent
    function execute(ProcessEnvironment environment)
        // ID of the customer to display is contained in the execution
        data
        customerId = environment.getExecutionData( ).get(“customer-
        id”)
        // retrieve the details
        customerData = environment.retrieveDataset(“customer-db”,
“get-customer-details”, { id: customerId })
        customerRow = customerData.getData( )[1]
        // return a page showing the details
        resultHTML = “<html>
                          <body>
                            Customer Name: “ + customerRow[1] +
“<br/>” +
                            Customer Address: “ + customerRow[2] +
“<br/>” +
                            Customer Phone: “ + customerRow[3] +
“<br/>” +
                            Customer Email: “ + customerRow[4] +
“<br/>” +
                          </body>
                    </html>”
        // Return the result through the process environment
        environment.returnExecutionResult(resultHTML)
    end function
end structure
```

The process environment that performs an execution in response to a web browser request can be implemented with the following algorithm:

```
structure ProcessEnvironmentImplementation implements
ProcessEnvironment
    webRequest
    // Created with a reference to the current web request
    constructor(WebRequest request)
        webRequest = request
    end constructor
    function getExecutionData( ) returns Map
        return webRequest.getRequestParameters( )
    end function
    function returnExecutionResult(Object result)
        // Here the result is written to the result stream to be the response
        to the browser
        webRequest.getOutputStream( ).write(result)
        webRequest.getOutputStream( ).close( );
    end function
end structure
```

While the present disclosure has been illustrated by the description of the embodiments thereof, and while the embodiments have been described in detail, it is not to restrict or in any way limit the scope of the appended claims to such detail. Additional advantages and modifications will readily appear to those skilled in the art. Therefore, this disclosure in its broader aspects is not limited to the specific details, representative apparatus and method, and illustrative examples shown and described. Example embodiments have been described hereinabove regarding systems and methods for implementing and executing computer processes in process environments. Various modifications to and departures from the disclosed example embodiments will occur to those having ordinary skill in the art. The subject matter that is intended to be within the spirit of this disclosure is set forth in the following claims.

1. A computer implemented method comprising: extracting a computer process from a first environment including a unique process parameter and a first non-unique process parameter, the computer process configured to execute a primary domain operation; implementing the computer process in a second environment comprising the unique process parameter and a second non-unique process parameter; inputting the unique process parameter to the computer process; and executing the primary domain operation with the computer process in the second environment in response to inputting the unique process parameter to the computer process.

2. The computer implemented method according to claim 1, wherein the unique process parameter is at least one parameter selected from the group comprising: a computer process component parameter and a process environment parameter.

3. The computer implemented method according to claim 1, further comprising: inputting the second non-unique process parameter to a collateral computer process; and executing a collateral domain operation with the collateral computer process in response to inputting the second non-unique process parameter to the collateral computer process.

4. The computer implemented method according to claim 3, wherein the second non-unique process parameter is at least one parameter selected from the group comprising: a computer process component parameter and a process environment parameter.

5. The computer implemented method according to claim 1, wherein the primary domain operation is at least one operation selected from the group comprising: an authentication operation, a data retrieval operation, a data augmentation operation, a data persistence operation, and a data transmission operation.

6. A computer implemented method comprising: providing a process environment comprising at least one unique process parameter and at least one non-unique process parameter; providing a computer process configured to execute a primary domain operation in the process environment; providing an interface for transmitting data to the computer process through the interface; providing, through the interface, a request for the execution of a data retrieval operation; receiving data from the data retrieval operation through the interface in response to the request for the execution of the data retrieval operation; inputting the at least one unique process parameter and the data to the computer process; and executing the primary domain operation with the computer process in response to inputting the at least one unique process parameter and the data to the computer process.

7. The computer implemented method according to claim 6, wherein the at least one unique process parameter is at least one parameter selected from the group comprising: a computer process component parameter and a process environment parameter.

8. The computer implemented method according to in claim 6, further comprising augmenting the data received from the data retrieval operation.

9. The computer implemented method according to claim 6, further comprising: providing, through the interface, a request for the execution of a data persistence operation; and persisting data to an external storage system in response to the request for the execution of the data persistence operation.

10. The computer implemented method according to claim 6, further comprising: providing, through the interface, a request for the execution of an authentication operation; and performing the authentication operation in response to the request for the execution of the authentication operation.

11. A computer-readable medium comprising computer-readable code stored on the computer-readable medium for causing a computer to perform the method of claim 1.

12. A device comprising: a processor configured to: extract a computer process from a first environment including a unique process parameter and a first non-unique process parameter, the computer process configured to execute a primary domain operation; implement the computer process in a second environment comprising the unique process parameter and a second non-unique process parameter; input the unique process parameter to the computer process; and execute the primary domain operation with the computer process in the second environment in response to inputting the unique process parameter to the computer process.

13. The device according to claim 12, wherein the processor is further configured to: input the second non-unique process parameter to a collateral computer process; and execute a collateral domain operation with the collateral computer process in response to inputting the second non-unique process parameter to the collateral computer process.

14. A device comprising: a processor configured to: provide a process environment comprising at least one unique process parameter and at least one non-unique process parameter; provide a computer process configured to execute a primary domain operation in the process environment; provide an interface for transmitting data to the computer process through the interface; provide, through the interface, a request for the execution of a data retrieval operation; receive data from the data retrieval operation through the interface in response to the request for the execution of the data retrieval operation; input the at least one unique process parameter and the data to the computer process; and execute the primary domain operation with the computer process in response to inputting the at least one unique process parameter and the data to the computer process.

15. The device according to claim 14, wherein the processor is further configured to augment the data received from the data retrieval operation.
